(19) United States
(12) Patent Application Publication
(10) Pub. No.: US 2007/0087150 A1
(43) Pub. Date: Apr. 19, 2007

(54) Tubular Copolyester Member for Tubing and Hose Constructions

(76) Inventors: Steven M. Powell, Chardon, OH (US); Nick Martino, N. Canton, OH (US); James Johnston, Canton, OH (US); Jimmy Hensley, Ravenna, OH (US); William C. Fisher, Cuyahoga Falls, OH (US)

Correspondence Address: JOHN A MOLNAR JR;PARKER-HANNIFIN CORPORATION, 6035 PARKLAND BOULEVARD, CLEVELAND, OH, 44124-4141, US

(21) Appl. No.: 11/550,616

(22) Filed: Oct. 18, 2006

Related U.S. Application Data
(60) Provisional application No. 60/728,194, filed on Oct. 19, 2005.

(51) Int. Cl. B29C 47/00; B32B 1/08

(52) U.S. Cl. 428/36.9

(57) ABSTRACT

Tubular polymeric member for articles such as tubing and hoses. The member is formed of composition of a copolyester thermoplastic elastomer material.

### CROSS-REFERENCE TO RELATED CASES

The present application claims the benefit of the filing date of U.S. Provisional Application Ser. No. 60/728,194; filed Oct. 19, 2005, the disclosure of which is expressly incorporated herein by reference.

### BACKGROUND OF THE INVENTION

The present invention relates broadly to tubular copolyester members and to articles such as hoses and tubing, which may be straight or coiled, constructed thereof, and more particularly to such members and to such articles for airbrake tubing.

Tractor/trailer rigs and other heavy-duty vehicles are conventionally are equipped with pneumatically-operated emergency brakes in addition to usual service airbrakes. In basic operation, and as is further described in U.S. Pat. No. 5,232,645 and U.K. Pat. Appln. GB 2,239,503, pressurized air is supplied from the truck unit to the trailer unit, which may be articulated, for the actuation of the emergency and service brake systems of the trailer. Within the emergency brake system, the braking mechanism normally is released under the condition of a constant air pressure supply. The service brake system, however, is manually actuated with pressurized air being supplied to the breaking mechanism upon the Appln. of the brake pedals by the operator.

Pressurized air from the truck to the trailer unit, or between trailer units in tandem rigs, may be supplied via flexible tubing or hose, with separate, dedicated lines being provided for the independent operation of the emergency and service brake systems. Performance requirements for airbrake tubing generally are subject to various governmental or industry regulations promulgated to ensure the safe operation of the vehicle. In this regard, airbrake tubing conventionally is constructed as having tubular core which optionally may be surrounded, in certain tubing types, by one or more layers of a braided or other wound reinforcement. The core tube may be a thermoplastic material such as a polyamide, polyolefin, polyvinyl chloride, or polyurethane, or a synthetic rubber material such as Bana N or neoprene, with the optional reinforcement preferably being a nylon, polyester, or aramid filament or yam. For increased abrasion resistance, the core tube and, as the case may be, reinforcement typically are covered with an outer jacket which may be formed of the same or different material as the core tube, but preferably is formed of more abrasion-resistance polymeric material which may be a polyamide, polyolefin, polyvinyl chloride, or polyurethane. Representative airbrake and other tubing constructions, and coils and bundles formed of such tubing, are described in U.S. Pat. Nos. 6,776,195; 6,670,004; 6,576,312; 6,354,331; 6,098,666; 6,071,579; 6,066,377; 5,392,541; 5,232,645; 4,653,541; 4,009,734; 3,977,440; and RE38,087; U.S. Ser. No. 11/331,964, filed Jan. 13, 2006, titled “Tubular Nylon Alloy Members for Tubing and Hose Constructions,” U.S. Pat. Appln. Publs. 2004/0134555; 2004/005811; and 2003/0145896, GB 2367108, WO 99/41537, and U.K. Pat. Appln. 2,239,503. Commercial airbrake tubing and coils are manufactured and sold by the Parflex Division of Parker-Hannifin Corp., Ravenna, Ohio.

Other tubing constructions, such as multi-layer constructions used for fuel line applications, incorporate a bonding or tie layer between an inner fluoropolymer layer or liner and a second layer of a stronger, tougher, and, typically, less-expensive material, such as a nylon, polyamide, or polyurethane, which is used as a reinforcement or cover for the liner. The tie layer, which may be formed as a co- or tri-extrusion with the liner and second layers, is formulated to be compatible chemically with both the fluoropolymer material of the liner and the material of the second layer such that a thermal fusion bond may be achieved between the liner and tie layer and the tie layer and second layer to thereby consolidate the tubing into an integral structure. The use of such tie layers dictates the selection of specific materials for the liner and second layer so as to be compatible with the material of the tie layer, or vice versa, and is believed limited to the use of melt processible fluoropolymers such as polyvinylidene fluoride (PVDF) or ethylene tetraflurorethylene (ETFE).

Multi-layer tubing constructions in general are shown in commonly-assigned U.S. Pat. No. 6,776,195. Other constructions are shown in U.S. Pat. Nos. 6,066,377; 6,041,826; 6,039,085; 6,012,496; 5,996,642; 5,937,911; 5,891,373; 5,884,672; 5,884,671; 5,865,218; 5,743,304; 5,716,684; 5,678,611; 5,570,711; 5,566,720; 5,524,673; 5,507,320; 5,500,263; 5,480,271; 5,469,892; 5,460,771; 5,419,374, 5,383,087; 5,284,184; 5,219,003; 5,167,259; 5,167,259; 5,112,692; 5,112,692; 5,093,166; 5,076,329; 5,076,329; 5,038,833; 5,038,833; 4,706,713; 4,627,844; and 3,561,493, in German Pat. Publ. Nos. DE 4001126; 3942354; and 3921723; and 3821723, in Japanese Pat. Publ. Nos. JP 61171982; 4224939; and 140585, in Europe Pat. Publ. Nos. EP 1002980, 992518, and 551094, in International (PCT) Publ. Nos. WO 99/41538; 99/41073; 97/44186; and 93/21466, and in U.K. Pat. Publ. No. GB 2204376.

It is believed that alternative single and multi-layer tubular polymeric members would be useful for airbrake tubing applications, and in a variety of other fluid transfer and motion control applications. In this regard, in severe or even normal service environments, such as in mobile or industrial pneumatic or hydraulic applications, hoses and tubing of the type herein involved may be exposed to a variety of environmental factors and mechanical stresses that cannot always be predicted. It is anticipated, therefore, that tubing and hose constructions which offer comparable performance, but which are more economical would be well-received by numerous industries.

### BROAD STATEMENT OF THE INVENTION

The present invention is directed to tubular polymeric members, which may formed by extrusion, co-extrusion, or molding, and articles such as single or multi-layer tubing and hoses, which may be straight or coiled, constructed thereof. More particularly, the invention is directed to such members which are formed of a copolyester (COPE)-based thermoplastic elastomer (TPE) material or a blend of two or more such materials.

Advantageously, the use of the COPE-based TPE materials of the present invention allows for a mono-wall airbrake tubing construction meeting applicable DOT and SAE standards for airbrake tubing and coils such as SAE Standard J844, “Nonmetallic Air Brake System Tubing,” (June 1998), SAE Standard J2484, “Push-To-Connect Tube Fittings for Use in the Piping of Vehicular Air Brake,” (May 2000), and SAE Standard J1131, “Performance Requirements for SAE J844 Nonmetallic Tubing and Fitting Assemblies Used in Automotive Air Brake Systems,” (August 1998), and NHSA/DOT FMVSS 106 (49 CFR § 571.106). Additional advantages include mono- and multi-walled tubing constructions which offer improved performance over tubing formed of a polyamide such as Nylon 11 or 12, and at a lower cost. Such tubing, moreover, may be formed to exhibit low temperature flexibility and cold temperature impact resistance which is improved over that of Nylon 11 or 12 constructions, and to have a lower coefficient of friction for easier installation of long tubing or hose lengths in confined spaces, such as in the rigging of tractor-trailers. In such tubing articles, the COPE material also reduces migratory extrudation of oligomers which may be exhibited by plasticized Nylon 11 grades, with an attendant improvement in long-term flexibility and directional stability for reduced leakage. Should the burst strength of such tubing articles require improvement, additional or stronger yarns, or added layers thereof may be used in reinforced construction. In non-reinforced constructions, the tubing of the invention may be laminated in a multi-layer construction with a stiffer material such as a nylon.

The tubing members formed of the COPE material of the invention may be particularly adapted for use as single or multi-layer tubing for vehicular airbrake systems, and/or as a core tube or other element in a reinforced tubing and hose constructions, as well as in other applications requiring chemical resistance and/or compliance with industry or governmental standards. Typically in such constructions, the more chemically or environmentally-resistant layers such as the tubing member of the invention are provided as an innermost and/or outermost layer of the structure. In reinforced constructions, such member may be used as a core tube over which one or more layers of a fibrous reinforcement layer are braided or wound to provide resistance to internal or external pressures. Alternatively, such member may be used as an outer layer over the reinforcement layers.

The present invention, accordingly, comprises the materials and the articles constructed which are exemplified in the detailed disclosure to follow. Advantages of the present invention include a tubular COPE or COPE blend member which may be used alone as tubing or as core tube for hose, and which provides improved low temperature flexibility and cold temperature impact resistance with a lower coefficient of friction, and a reduction in reduces migratory extrudation of oligomers which is sometimes observed in plasticized Nylon 11 grades. The long-term flexibility and directional stability is also improved for a reduced leakage potential. These and other advantages should be apparent to those skilled in the art based upon the disclosure contained herein.

### BRIEF DESCRIPTION OF THE DRAWINGS

For a fuller understanding of the nature and objects of the invention, reference should be had to the following detailed description taken in connection with the accompanying drawings wherein:

FIG. 1 is a side elevational view of a single layer tubing member according to the present invention;

FIG. 2 is a side elevational, cut-away view of a representative multi-layer tubing construction according to the present invention; and

FIG. 3 is a side elevational view, cut-away view of a representative three layer reinforced tubing construction according to the present invention.

The drawings will be described further in connection with the following Detailed Description of the Invention.

### DETAILED DESCRIPTION OF THE INVENTION

Certain terminology may be employed in the description to follow for convenience rather than for any limiting purpose. For example, the terms “forward,” “rearward,” “right,” “left,” “upper,” and “lower” designate directions in the drawings to which reference is made, with the terms “inward,” “interior,” “inner,” or “inboard” and “outward,” “exterior,”“outer,” or “outboard” referring, respectively, to directions toward and away from the center of the referenced element, and the terms “radial” or “horizontal” and “axial” or “vertical” referring, respectively, to directions, axes, planes perpendicular and parallel to the central longitudinal axis of the referenced element. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Durometer specified herein may be understood to refer to nominal values.

For the illustrative purposes of the discourse to follow, the precepts of the tubular polymeric member of the invention herein involved are described in connection with its utilization as flexible tubing, which may be straight or coiled, such as for vehicular airbrake applications. It will be appreciated, however, that aspects of the present invention may find use in other tubing applications, such as in multiple tube bundles or as a core tube or other member within a flexible pressure or vacuum hose construction such as for hydraulic or pneumatic power, signaling, control, or general fluid transfer applications. Use within those such other applications therefore should be considered to be expressly within the scope of the present invention.

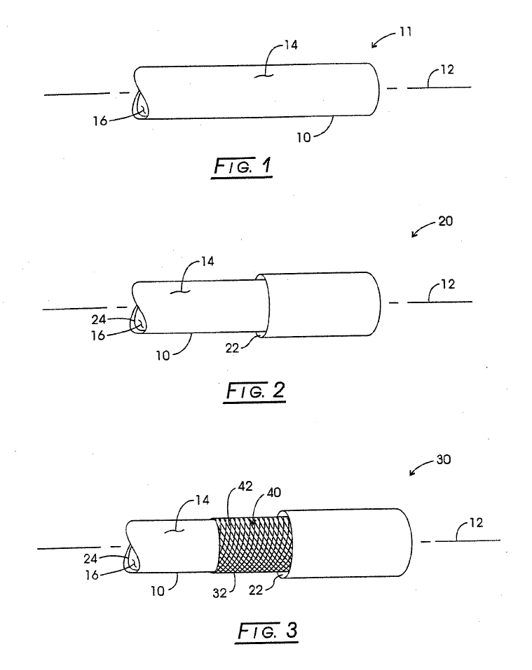

Referring then to the figures wherein corresponding reference characters are used to designate corresponding elements throughout the several views with equivalent elements being referenced with prime or sequential alphanumeric designations, a representative tubular polymeric member, 10, in accordance with the present invention is referenced generally at 11 in FIG. 1 as a length of a single layer tubing construction. In such tubing construction 11, member 10, which may be straight as shown or coiled, extends lengthwise along a central longitudinal axis, 12. In the embodiment shown, member 10 has a circumferential outer surface, 14, and a circumferential inner surface, 16.

Member 10 may be extruded or otherwise fabricated, such as by molding, of a composition of a copolyester (COPE)-based thermoplastic elastomer (TPE) material, or a blend of two or more such materials material, and, optionally, a heat age stabilizer and/or an impact modifier. As used herein, the term “thermoplastic” may be used interchangeably with “melt processible,” and is in contrast to non-melt processible materials such as thermosets or non-thermosetting materials which otherwise exhibit a melt viscosity that is sufficiently high so as to preclude flow and processing by conventional melt extrusion or molding operations, and therefore necessitating that the material be processed using sintering or solvent processing techniques. Such materials, which may be referred herein as “resins,” typically will have a melting point of between about 110-230° C., and a thermal decomposition temperature, which defines the upper processing limit of the resin, of between about 150-260° C. As also used herein, “melting point” may be a transition from a form-stable crystalline or glassy solid phase to a softened or otherwise viscous phase which may be generally characterized as exhibiting intermolecular chain rotation and, as between layers, chain diffusion and/or other intermingling. For amorphous or other thermoplastic resins not having a clearly defined melting peak, the term melting point is used interchangeably with glass transition or softening point.

As mentioned, the COPE material of the composition, as well as the impact modifier and/or stabilizer themselves, may be blends, such as in the case of the COPE material or other polymeric material, of a blend of one or more homopolymers, one or more copolymers, or one or more homopolymers and one or more copolymers. Also, the composition itself may be may be unfilled or, alternatively, compounded with one or more fillers, modifiers, or other additives. Such additives, which may be in liquid, powder, particulate, flake, fiber, or other form, may include electrically-conductive fillers, microwave-attenuating fillers, thermally-conductive fillers, lubricants, wetting agents, stabilizers, antioxidants, pigments, dyes, colorants, colorings, or opacifying agents such as for coloring-coding of the tubing, luminescents, light reflectants, chain extending oils, tackifiers, blowing agents, foaming or anti-foaming agents, reinforcements such as glass, carbon, or textile fibers, and fire retardants such as halogenated compounds, metal oxides and salts, intercalated graphite particles, borates, siloxanes, phosphates, glass, hollow or solid glass or elastomeric microspheres, silica, silicates, mica, and the like. Typically, the additives are blended or otherwise admixed with the base material, and may comprise between about 0.1% and 80% or more by total volume of the formulation.

The impact modifier may be a maleic anhydride (MAH) grafted polyolefin (Fusabond®, Dupont), or an ethylene/methacrylic copolymer-based ionomer resin such as Suryln® (DuPont, Wilmington, Del.), or other ethylene copolymer resin which may be a high-molecular-weight copolymer resin such as an EVACO (ethylene/vinyl acetate/carbon monoxide), EBACO (ethylene/butyl acrylate/carbon monoxide), or EnBAGMA (ethylene/n-butyl acrylate/glycidyl methacrylate) terpolymer resin (Elvaloy®, Dupont). The heat age stabilizer, in turn, may be a polybutylene terephthalate (PBT), or a proprietary additive such as “E1” from DSM Engineering Plastics (Evansville, Ind.).

As to the COPE-based TPE material or blend, for airbrake tubing applications, such material may be a block or other copolymer such as a polyether-ester or a polyester-ester copolymer, or otherwise formed of by the reaction of one or more diols and one or more diacids. In the case of a polyether-ester copolymers, such copolymers may be random block copolymers, such as based or, poly(butyleneterephthalate) and polytetramethyleneglycol. Such block copolymers may repeatedly alternately, randomly or otherwise, between hard, i.e., crystallizable, segments and soft, i.e., low crystallinity segments, and are typically polymerized by melt trans-esterification of a caboxylic acid, or its methyl ester, a polyalkylene oxide, and a short chain diol.

Random block poly(ether-ester) copolymers are marketed commercially as, for example, Arnitel® EM630 and EM740 (DSM Engineering Plastics, Evansville, Ind.). As to such materials, grades having a hardness between about 50-80 Shore D and, preferably, between about 60-75 Shore D, may be considered particularly suitable for airbrake tubing applications.

In the mono- or multi-wall tubing constructions of the present invention, a blend of such random block or other poly(ether-ester) copolymers may be used, and particularly a blend of a harder, i.e., higher Shore A or other durometer, and softer, i.e., lower Shore D or other durometer, material. The harder material may have a Shore D durometer of between about 70-75, with the softer material having a Shore D durometer of between about 60-65. The blend, based on the COPE materials by weight, may be between about 20-80% of the softer material, and between about 20-80% of the harder material. A more preferred blend may be between about 70-80% of the softer material and between about 20-30% of the harder material, with a particularly preferred blend being about 65% of a 60 Shore D material such as EM630 and about 35% of a 72 Shore D material such as EM740.

More broadly, in reinforced multi-wall constructions, between about 20-100% of the softer material may be used for improved flexibility, while in mono-wall constructions between about 0-80% of the softer material may be used for improved strength. It will be appreciated that the blend ration may varying depending upon such factors as the tubing diameter and wall thickness, and the amount of impact modified added to the formulation.

Advantageously, the COPE-based TPE compositions herein involved are compatible for chemical or fusion co-extrusion bonding with common engineering thermoplastics such as PVCs, polyolefins, PVDFs, and TPUs. In this regard, looking next to FIG. 2, a multi-layer tubing construction incorporating member 10 of FIG. 1 is referenced generally at 20. Such construction 20 is formed as a 2-layer laminate of a tubular outermost layer, 22, and a tubular innermost layer, 24, formed by the member 10, which is concentric with the outermost layer 18, and which inner surface 16 thereof forms the innermost surface of the construction 20. Layer 22 also may be formed of a thermoplastic polymer material which may be formulated as the same alloy as described in connection with the member 10. Alternatively, layer 22 may be formed of a general purpose resin such as a polyester, polyurethane, or polyurethane. For airbrake tubing applications, however, layer 22 may be a polyamide or blend, and particularly a polyamide of the type commonly used in such applications, such as a plasticized or unplasticized nylon which may be Nylon 6, 6/66, 6/12, or, typically 11 or 12. As before, the material forming the layer 22 may be filled or unfilled, and may be a homo or copolymer, or a blend thereof, i.e., a blend of one or more homopolymers, one or more copolymers, or one or more homopolymers and one or more copolymers.

With the layers 22 and 24 each being formed of a thermoplastic material, the tubing construction 20 may be formed by continuous co-extrusion or other extrusion such as cross-head or sequential extrusion. Alternatively, the layers 22 and 24 may be molded or co-molded, or otherwise formed, such as via coating, or a combination of extrusion, molding, and/or coating. If formed of compatible materials, the layers 22 and 24 may be directly bonded together, such as by thermal fusion bonding, to form an integral, composite or laminate structure. Otherwise, if adjoining, the layers may be made into a composite via the use of an intermediate adhesive, tie, or other layer (not shown). Indeed, in other multi-layer construction, one or more additional layers, which may be the same as or different than the layers 22 and 24, may be provided in combination with those layers. Also, in any of the onstructions, the layers may be reversed such that the outer surface 14 of the layer 24 forms he outermost surface of the construction.

Moreover, in a hose construction, one or more reinforcement or additional resin layers, or a cover or jacket (not shown), may be knitted, braided, woven, wound, or wrapped in the case of a fiber, wire, metal foil, tape, film, or the like, or, alternatively, extruded, molded, or coated such as in the case of an additional resin layer resin layer, on or about, or otherwise as surrounding the construction 20 which, in such instance, may function as a core tube for such hose. The materials forming the reinforcement, cover, or additional resin layers may be loaded with metals, carbon black, pigments, dyes, reflectants or another fillers in particulate, flake, fiber, or other form so as to render the such construction electrically-conductive for applications requiring electrical conductivity or static dissipation, and/or, depending upon the filler, for providing color coding or increased visibility. Separate electrically-conductive or reflective fiber or resin layers, wires, and other elements (not shown) also may be incorporated within, in, or on the multi-layer structure of the construction 20 such as to provide electrical conductivity, static dissipation, or increased visibility The wall thicknesses of each of the layers 22 and 24 in the construction 20 may be of any thickness, both absolute and relative to the thickness of the other layer, but for many applications will be between about 5-250 mils (0.13-6.35 mm).

Turning lastly to FIG. 3, a representative 3-layer tubing construction incorporating member 10 of FIG. 1 is referenced generally at 30. Such construction 30 is similar to that of the construction 20, with the exception that one or more reinforcement layers, 32, is interposed between the layers 22 and 24. In this regard, each of the one or more reinforcement layers 32 may be braided, woven, wound, such as spiral or helically, knitted, wrapped, or otherwise formed successively about, i.e., as surrounding, outer surface 14 of the inner layer 24, with the outer layer 22 then being extruded or otherwise formed over the reinforcement layer or layers 32. Each of the reinforcement layers 32 may be formed, of one or more filaments, which may be monofilaments, continuous multi-filament, i.e., yarn, stranded, cord, roving, thread, tape, or ply, or short “staple” strands, of one or more fiber materials, The fiber material, which may be the same or different in each of the layers 32 which are provided, may be a natural or synthetic polymeric material such as a nylon, cotton, polyester, polyamide, aramid, polyolefin, polyvinyl alcohol (PVA), polyvinyl acetate, or polyphenylene bezobisoxazole (PBO), or blend, a steel, which may be stainless or galvanized, brass, zinc or zinc-plated, or other metal wire, or a blend thereof.

For airbrake tubing applications, and as is shown in FIG. 3, a single reinforcement layer 32 typically will be provided as braided of a nylon, polyester, or aramid filament or yarn, and as having a relatively open structure with interstices, one of which is referenced at 40, between the filaments, referenced at 42, of the braid. The outer layer 22 thereby may be fusion or otherwise bonded to the inner layer 24 through the interstices 40, with the reinforcement layer 32 itself being bonded to or between the layers 22 and 24 mechanically, such as by embedded in or encapsulated between the layers 22 and 24, or by other bonding means such as fusion, chemical, or adhesive bonding, or a combination thereof or otherwise. Such other bonding means may be effected by solvating, tackifying, or plasticizing the surfaces of the layers 22 and/or 24 with an appropriate solvent, such as a carboxylic or other organic acid, tackifier, or plasticizer such as an aqueous or other solution of an amine such as n-methyl pyrrolidone or a phenol such as meta-cresol or resorcinol, or with the use of a urethane, epoxy, vinyl chloride, vinyl acetate, methyl acrylic, or other adhesive having an affinity to the materials forming the layers 22 and 24, or otherwise in the manner described, for example, in U.S. Pat. Nos. 3,654,967; 3,682,201; 3,773,089; 3,790,419; 3,861,973; 3,881,975; 3,905,398; 3,914,146; 3,982,982; 3,988,188; 4,007,070; 4,064,913; 4,343,333; 4,898,212; and 6,807,988 and in the references cited therein, and in Japanese (Kokai) Publ. No. 10-169854 A2 and Canadian Pat. No. 973,074.

The table below compares the physical properties of representative mono- and multi-wall tubing constructions in accordance with the present invention, with a mono-wall construction formed of a more conventional polyester material (Dupont Hytrel® HTR8163HVBK, 65 Shore D thermoplastic polyester elastomer).

TABLE

| | | | 75% EM630⁺ | 100% | 100% |
|---|---|---|---|---|---|
| Property | Test Method | HTR8163^{*} | 25% EM740^{+,#} | EM630^{+,@} | EM740⁺ |
| Tensile Strength @ 10% Strain, MPa | ISO 527-1-2 | 17.8 | 20 | 15.9 | |
| Tensile Strength @ 50% Strain, MPa | ISO 527-1-2 | 20 | 24 | 18 | |
| Stress @ Break, MPa | ISO 527-1/-2 | 30 | 29 | 38 | |
| Strain @ Break, % | ISO 527-1/-2 | 250 | 216 | >300 | |
| Tensile Modulus, MPa | ISO 527-1/-2 | 360 | 456 | 310 | 900 |
| Hardness, Shore D, @ 15 s | ISO 868 | 62 | 53 | | |
| Hardness, Shore D, Maximum | ISO 868 | 65 | | 63 | 74 |
| Yield Stress MPa | ISO 527-1/-2 | | | 20 | |
| Yield Strain, % | ISO 527-1/-2 | | | 29 | |
| Strain @ Break, % | ISO 527-1/-2 | | | >50 | |

^{*}Dupont
⁺DSM Engineering Plastics
^{#}Mono-wall
^{@}Reinforced

Advantageously, the mono-wall construction of the invention may meet applicable DOT burst-strength and other performance standards without the need for a yarn or other reinforcement layer. Such construction additionally may be provided as having a generally smooth, i.e., non-wavy, outer surface attributable to the use of a reinforcement layer.

Thus, single and multi-layer tubing and hose constructions incorporating the tubular polymeric member of the present invention have been described.

As it is anticipated that certain changes may be made in the present invention without departing from the precepts herein involved, it is intended that all matter contained in the foregoing description shall be interpreted as illustrative and not in a limiting sense. All references including any priority documents cited herein are expressly incorporated by reference.

What is claimed is:

1. A tubular polymeric member formed of a composition comprising a copolyester thermoplastic elastomer material.

2. The tubular polymeric member of claim 1 wherein the copolyester thermoplastic elastomer material has a durometer of between about 50-80 Shore D.

3. The tubular polymeric member of claim 1 wherein the copolyester thermoplastic elastomer material has a durometer of between about 60-75 Shore D.

4. The tubular polymeric member of claim 1 wherein the copolyester thermoplastic elastomer material is a polyether-ester block copolymer.

5. The tubular polymeric member of claim 1 wherein the copolyester thermoplastic elastomer material is a block copolymer of poly(butyleneterephthalate) and polytetramethyleneglycol.

6. The tubular polymeric member of claim 1 wherein the copolyester thermoplastic elastomer material is a random block copolymer of higher crystallinity segments and lower crystallinity segments.

7. The tubular polymeric member of claim 1 wherein the copolyester thermoplastic elastomer material is a blend of a harder grade copolyester thermoplastic elastomer and a softer grade copolyester thermoplastic elastomer.

8. The tubular polymeric member of claim 7 wherein the harder grade copolyester thermoplastic elastomer has a durometer of between about 70-75 Shore D, and the softer grade copolyester thermoplastic elastomer has a durometer of between about 60-65 Shore D.

9. The tubular polymeric member of claim 7 wherein the harder grade copolyester thermoplastic elastomer has a durometer of about 72 Shore D, and the softer grade copolyester thermoplastic elastomer has a durometer of about 60 Shore D.

10. The tubular polymeric member of claim 7 wherein the copolyester thermoplastic elastomer material comprises, based on the total weight of the material, between about 20-80% of the softer grade copolyester thermoplastic elastomer, and between about 20-80% of the harder grade copolyester thermoplastic elastomer.

11. The tubular polymeric member of claim 7 wherein the copolyester thermoplastic elastomer material comprises, based on the total weight of the material, between about 70-80% of the softer grade copolyester thermoplastic elastomer, and between about 20-30% of the harder grade copolyester thermoplastic elastomer.

12. The tubular polymeric member of claim 7 wherein the copolyester thermoplastic elastomer material comprises, based on the total weight of the material, about 65% of the softer grade copolyester thermoplastic elastomer, and about 35% of the harder grade copolyester thermoplastic elastomer.

13. The tubular polymeric member of claim 7 wherein the composition comprises between about 0-80% of the softer grade copolyester thermoplastic elastomer.

14. The tubular polymeric member of claim 7 wherein the composition comprises between about 20-100% of the softer grade copolyester thermoplastic elastomer.

15. An article comprising a tubular polymer member, the tubular polymeric composite member forming a tubular first layer within the member and being formed of a composition comprising a copolyester thermoplastic elastomer material.

16. The article of claim 15 further comprising:
a tubular second layer concentric with the first layer, the second layer being formed of a thermoplastic material different from the polyester thermoplastic elastomer material of the first layer.

17. The article of claim 15 further comprising:
a tubular reinforcement layer concentric with the first layer, the reinforcement layer formed of one or more filaments of one or more fibers.

18. The article of claim 17 further comprising.
a tubular second layer concentric with the first layer and the reinforcement layer, the reinforcement layer being interposed between the first and the second layer.

19. The article of claim 18 wherein the second layer is formed of a composition comprising the copolyester thermoplastic elastomer material of the composition of the first layer.

20. The tubular polymeric member of claim 15 wherein the copolyester thermoplastic elastomer material is a blend of a harder grade copolyester thermoplastic elastomer and a softer grade copolyester thermoplastic elastomer.

21. The tubular polymeric member of claim 20 wherein the harder grade copolyester thermoplastic elastomer has a durometer of between about 70-75 Shore D, and the softer grade copolyester thermoplastic elastomer has a durometer of between about 60-65 Shore D.

22. The tubular polymeric member of claim 20 wherein the harder grade copolyester thermoplastic elastomer has a durometer of about 72 Shore D, and the softer grade copolyester thermoplastic elastomer has a durometer of about 60 Shore D.

23. The tubular polymeric member of claim 20 wherein the copolyester thermoplastic elastomer material comprises, based on the total weight of the material, between about 0-80% of the softer grade copolyester thermoplastic elastomer.

24. The tubular polymeric member of claim 20 wherein the copolyester thermoplastic elastomer material comprises, based on the total weight of the material, between about 70-80% of the softer grade copolyester thermoplastic elastomer, and between about 20-30% of the harder grade copolyester thermoplastic elastomer.

25. The tubular polymeric member of claim 20 wherein the copolyester thermoplastic elastomer material comprises, based on the total weight of the material, about 65% of the softer grade copolyester thermoplastic elastomer, and about 35% of the harder grade copolyester thermoplastic elastomer.

26. The tubular polymeric member of claim 17 wherein the copolyester thermoplastic elastomer material is a blend of a harder grade copolyester thermoplastic elastomer and a softer grade copolyester thermoplastic elastomer.

27. The tubular polymeric member of claim 26 wherein the harder grade copolyester thermoplastic elastomer has a durometer of between about 70-75 Shore D, and the softer grade copolyester thermoplastic elastomer has a durometer of between about 60-65 Shore D.

28. The tubular polymeric member of claim 26 wherein the harder grade copolyester thermoplastic clastomer has a durometer of about 72 Shore D, and the softer grade copolyester thermoplastic elastomer has a durometer of about 60 Shore D).

29. The tubular polymeric member of claim 26 wherein the copolyester thermoplastic elastomer material comprises, based on the total weight of the material, between about 20-100% of the softer grade copolyester thermoplastic elastomer.
